(19) United States
(12) Patent Application Publication
(10) Pub. No.: US 2020/0269921 A1
(43) Pub. Date: Aug. 27, 2020

(54) Sub-Frame and Step Assembly for Truck

(71) Applicant: Michael John Silveri, Boca Raton, FL (US)

(72) Inventor: Michael John Silveri, Boca Raton, FL (US)

(21) Appl. No.: 16/798,006

(22) Filed: Feb. 21, 2020

Related U.S. Application Data
(60) Provisional application No. 62/808,517, filed on Feb. 21, 2019.

(51) Int. Cl. B62D 21/02; B60R 3/00; B60R 5/00

(52) U.S. Cl. CPC B62D 21/02; B60R 5/00; B60R 3/00

(57) ABSTRACT

An assembly is described for connecting a step to a tow truck or other commercial truck using a sub-frame. The step is installed at a height that allows access by a user standing thereon to a bed of the truck and to any items located on the truck bed. The assembly also can feature a tool box installed on the sub-frame at a side of the tow truck. Left and right versions of the assembly can be made for installation on left and right sides of the truck, respectively.

### CROSS REFERENCE TO RELATED APPLICATIONS

This application is a nonprovisional application of and claims priority from U.S. provisional patent application Ser. No. 62/808,517 filed on Feb. 21, 2019. The foregoing application is incorporated in its entirety herein by reference.

### FIELD OF THE INVENTION

The invention relates to improvements for a tow truck or other commercial truck. More particularly, the invention relates to a step assembly that is connected to a tow truck or other commercial truck using a sub-frame.

### BACKGROUND

Tow trucks and other commercial truck vehicles lack a step or other means to access a bed of the vehicle that is used for hauling vehicles or other cargo. Such trucks often also lack a toolbox capable of storing tools useful to the driver. In addition, the construction of such vehicles often leaves them unstable due to flexing of their frames.

A need exists for tow trucks and other commercial truck vehicles having a step so that a person may step up and stand upon the step to reach a bed of the truck. A need also exists for a means for attaching a toolbox to an exterior of a tow truck or other commercial truck vehicle. A further need exists for a stabilized frame for use in an assembled tow truck or other commercial truck vehicle.

### SUMMARY

The invention relates to an assembly (also referred to herein as a truck sub-frame and step assembly) for connecting a step to a tow truck or other commercial truck using a sub-frame. The sub-frame is connected to a chassis, or frame, of a truck, and the step (and any other components such as, for example, a tool box) is installed onto the sub-frame. The step is installed at a height that allows access by a user standing thereon to a bed of the truck and to any items located on the truck bed, e.g., to another vehicle that is located on a flatbed of a tow truck. The assembly also can feature a tool box installed on the sub-frame at a side of the tow truck. Left and right versions of the assembly can be made for installation on left and right sides of the truck, respectively.

The truck sub-frame and step assembly provides an advantage by providing tow trucks and other commercial truck vehicles with a step so that a person may step up and stand upon the step to reach a bed of the truck and any vehicle or cargo that is located on the bed. The truck sub-frame and step assembly provides another advantage by providing a means for attaching a toolbox to an exterior of a tow truck or other commercial truck vehicle. A further advantage is provided by the truck sub-frame and step assembly, by providing a stabilized frame for use in an assembled tow truck or other commercial truck vehicle.

Accordingly, the invention features a sub-frame and step assembly that includes a sub-frame installed on a chassis of a truck and a step assembly connected to the sub-frame at a height that allows access by a user standing thereon to a bed of the truck.

In another aspect, the invention can feature a tool box installed on the sub-frame.

The invention also features a truck that includes a sub-frame installed on a chassis of the truck and a step assembly connected to the sub-frame.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1A is a photograph of a top view of a sub-frame of a truck sub-frame and step assembly.

FIG. 1B is a photograph of a perspective side view of the sub-frame of FIG. 1A.

FIGS. 2A-2E are photographs of various side views of an exemplary embodiment of a truck sub-frame and step assembly, including an attached tool box and fender, configured and installed on a left side of a flatbed tow truck.

FIGS. 3A and 3B are photographs of exemplary embodiment of the truck sub-frame and step assembly, including an attached tool box and fender, configured and installed on a right side of a flatbed tow truck.

FIGS. 4-11 are photographs of various other views of the truck sub-frame and step assembly.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides an assembly for installation on a truck. The truck can be a tow truck or other commercial truck vehicle having a bed on which another vehicle or other cargo may be placed for transport. In exemplary embodiments, the assembly is installed on a flatbed tow truck. The assembly stabilizes the frame of the truck and is useful for attaching other components to the truck. The assembly includes a sub-frame that is attachable to a chassis (i.e., frame) of the truck. The assembly further includes a step that is connectable to the sub-frame. In some embodiments, the step may be connected to the sub-frame after the sub-frame is installed on the truck.

The sub-frame is constructed from two chassis connection elements arranged horizontally in parallel to one another and connected together via at least two support elements attached at intervals perpendicularly to both chassis connection elements.

The two classis connection elements are shaped as bars in preferred embodiments. Each chassis connection element has top and bottom sides, left and right sides, and first and second ends. The left and right sides of the chassis connection element are each wider than the top and bottom sides of the chassis connection element. The first and second ends of the chassis connection element can be the same height as the left and right sides and the same width as the top and bottom sides.

In some embodiments of the assembly, each chassis connection element includes an end plate installed on one end. For example, an end plate may be installed on the first end of a chassis connection element or on the second end of the chassis connection element. In exemplary embodiments, end plates may be installed on both the first and second ends of each chassis connection element. In other embodiments, end plates may be installed only on the first ends of the two chassis connection elements or only on the second ends of the two chassis connection elements. In still other embodiments, an end plate may be installed on the first end of one chassis connection element and on the second end of the other chassis connection element.

The end plate can be generally planar with a converging vertical surface profile, i.e., left and right sides of the end plate are nearer one another near a top portion of the end plate while the left and right sides of the end plate at a bottom portion of the end plate are more distant from one another. A top end of the end plate can be flush with a top side of the chassis connection element to which the end plate is attached. The end plate can be longer than the height of the chassis connection element to which it is attached so that a bottom end of the end plate extends beyond the bottom side of the chassis connection element. A rear side of the end plate's bottom end is connectable to the left or right side (depending on which end of the chassis connection element the end plate's support element is connected) of the support element that is attached to one end (i.e., the first end or second end) of one of the chassis connection elements.

The at least two support elements are also shaped as bars in preferred embodiments of the assembly. Each support element has top and bottom sides, left and right sides, and first and second ends. The top and bottom sides of the support element are each wider than the left and right sides of the support element. The first and second ends of the support element can be the same height as the left and right sides and the same width as the top and bottom sides.

In exemplary embodiments of the sub-frame, three support elements are attached to the two chassis connection elements: one support element attached on the bottom side near or at each end of each chassis support element and the third support element attached on the bottom side near or at a center of each chassis support element.

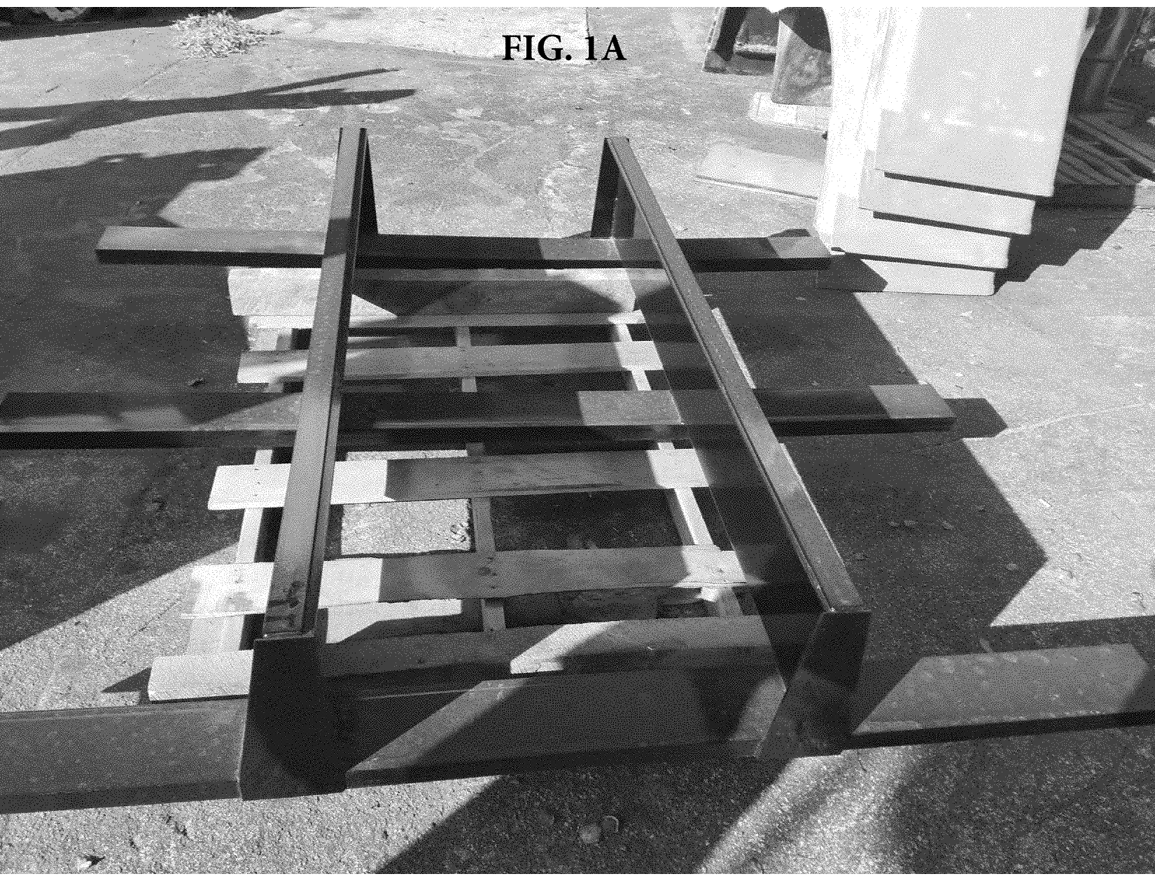

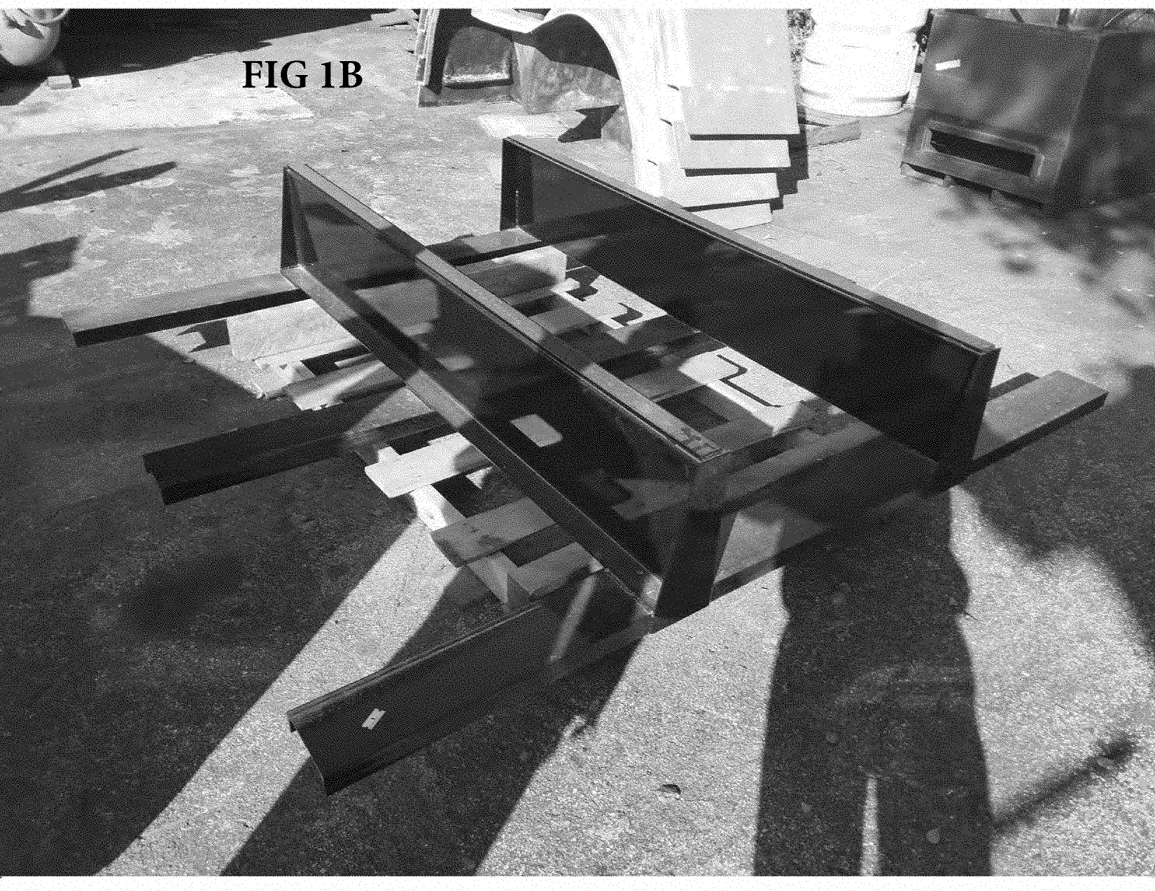

Once the two chassis connection elements and the support elements are assembled to create the sub-frame, the first and second ends of each support element extend beyond the left side of the left chassis connection element and beyond the right side of the right chassis connection element, as shown in FIG. 1.

The sub-frame is attached to the chassis of the truck from underneath the truck. No disassembly of the truck is required in order to attach the sub-frame of the assembly. The sub-frame is positioned beneath the truck and is lifted into position for attachment to the truck's chassis. The sub-frame may be connected to the chassis by bolts and brackets (e.g., ear brackets), welding, a combination of the foregoing, or any other suitable means of connecting the sub-frame and chassis together. Once connected to the chassis, the sub-frame serves to stiffen the chassis of the truck, thereby rendering it more stable.

After the sub-frame is attached to the chassis, a step may be attached to the first ends of the support elements. A second step may be attached to the second ends of the support elements. In this arrangement, each side of the truck include a step connected to the sub-frame so that a user may step onto and stand on the step to access the bed of the truck and any items located thereon (such as, for example, a vehicle sitting on the flatbed of a tow truck).

To install a step onto the sub-frame, the step is placed upon the sub-frame so that the step is “floating,” i.e., placed onto the top surfaces of the support elements but not yet attached thereto. Other items (e.g., a tool box, a fender, or both) may be attached to the sub-frame, to the step, or to both. Such additional items may be positioned as desired and attached to the sub-frame before the step is attached. For example, a tool box may be installed on the top surfaces of the support elements. After any such additional items have been installed and after the step has been centered, the step is attached (for example, by bolting and brackets) to the sub-frame.

In another embodiment, a rear fender may be attached to the rearmost support element of the sub-frame. In still another embodiment, a rear fender may be attached to a rearward end (e.g., the second end) of the step.

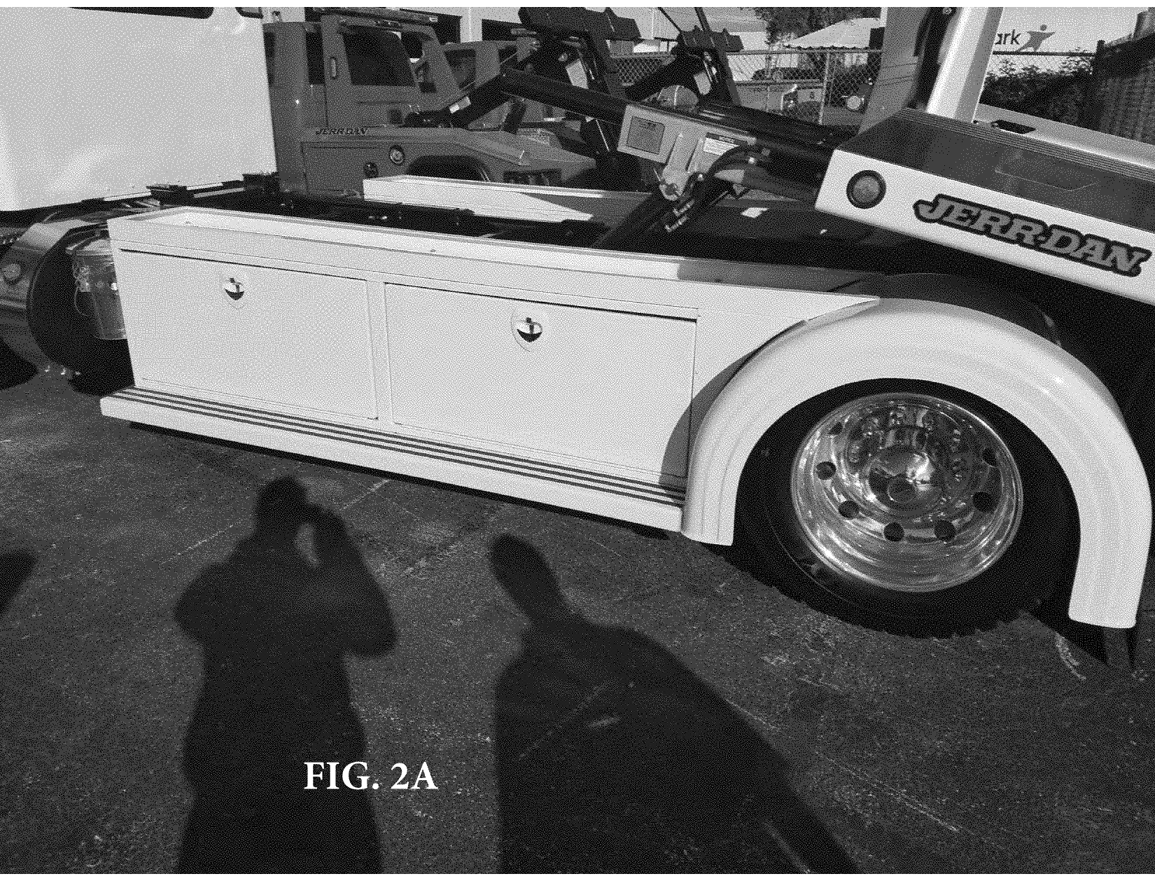

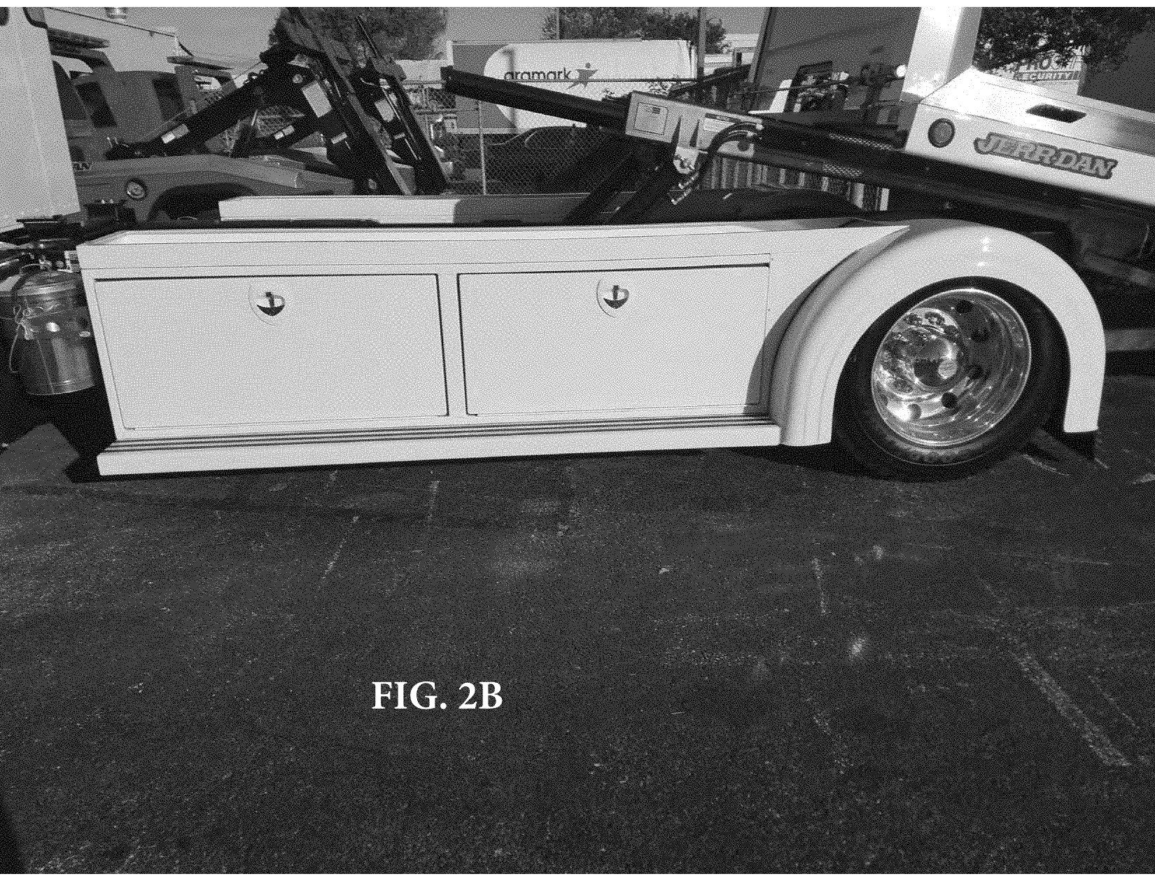

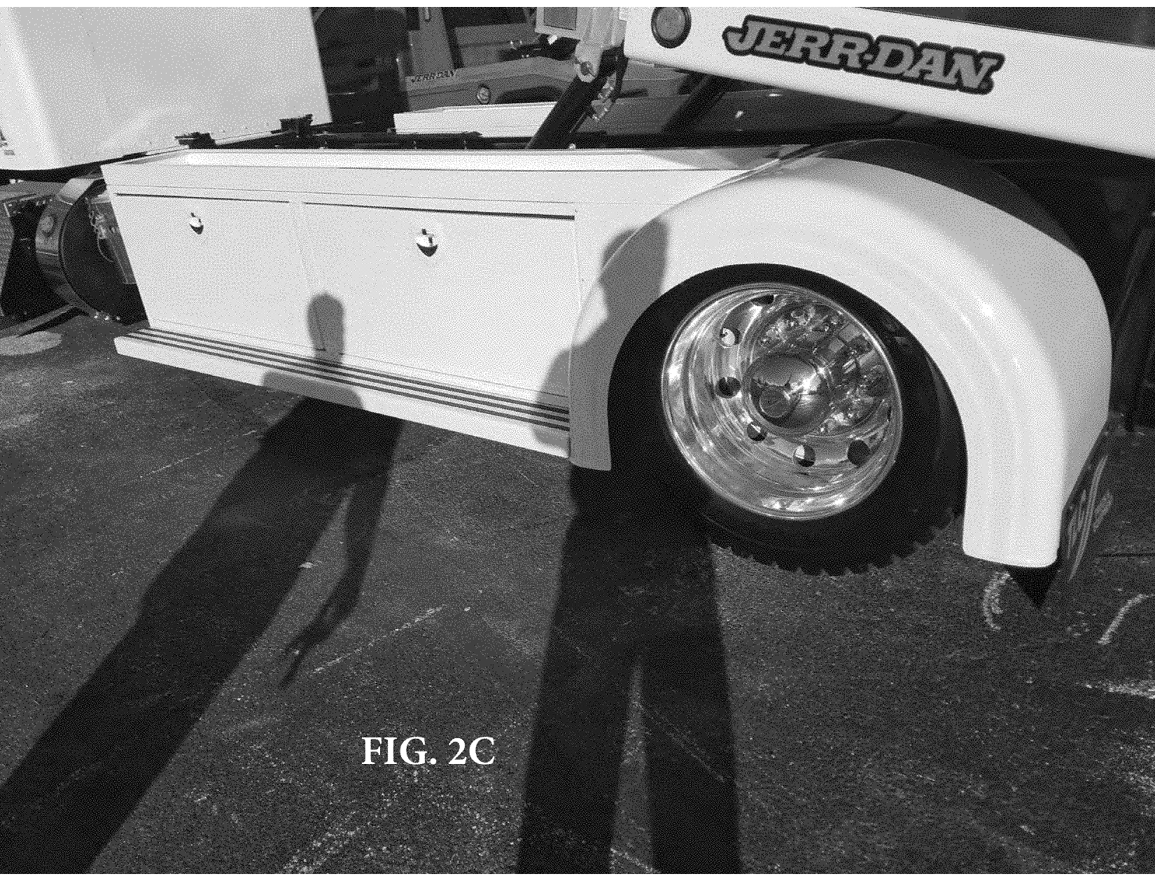

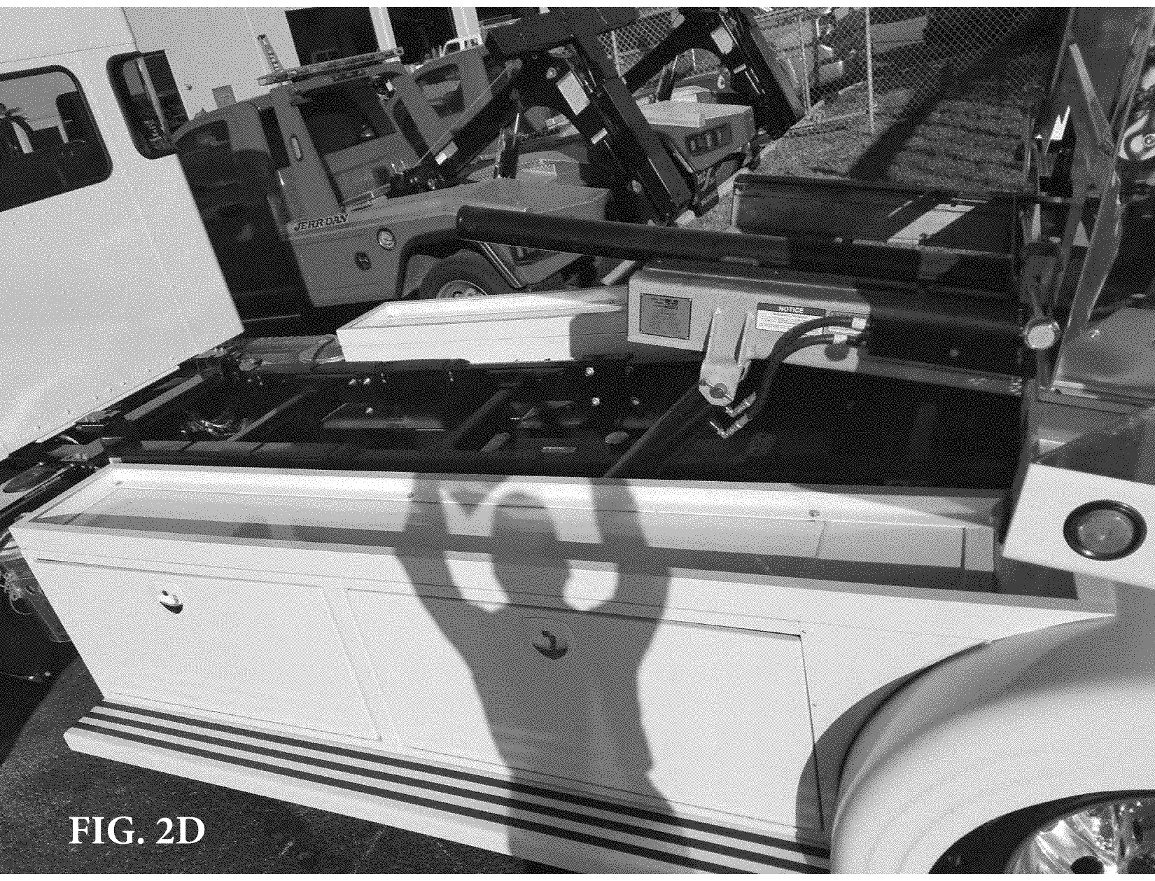

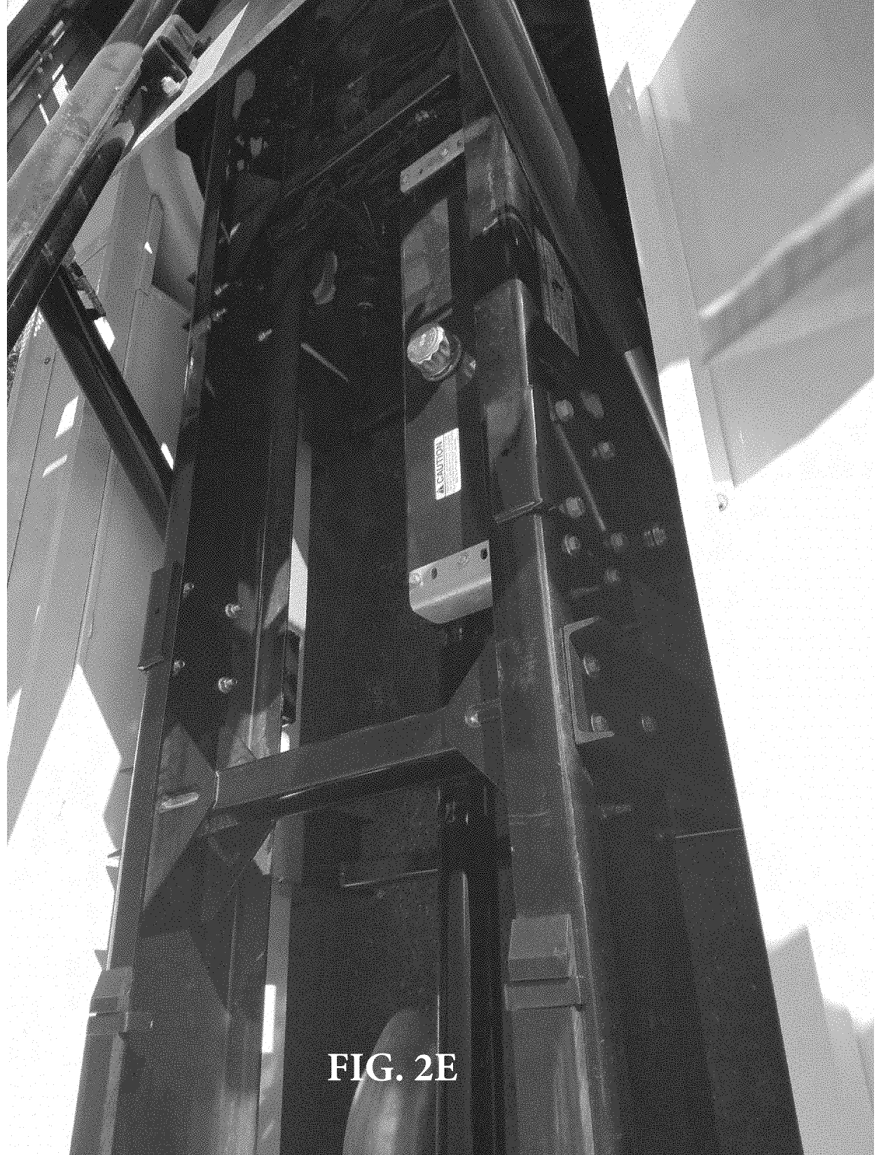

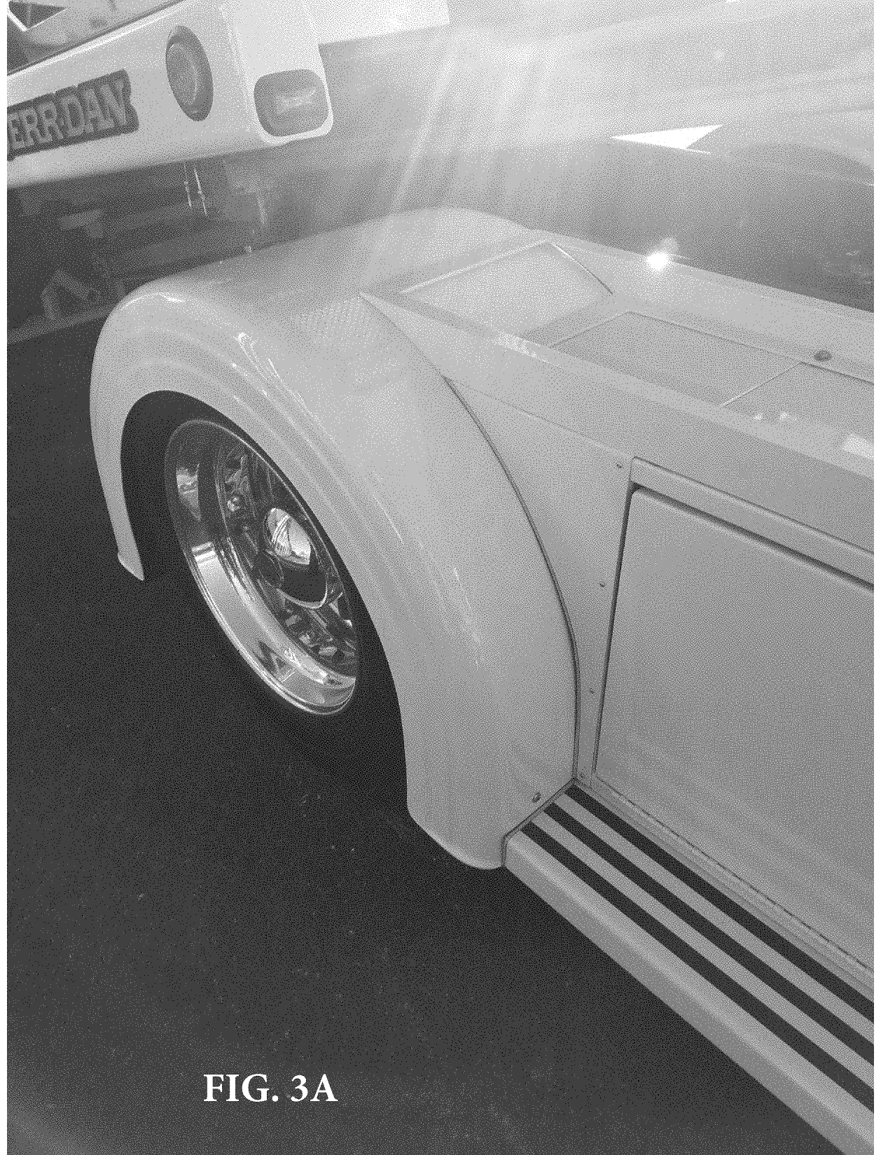

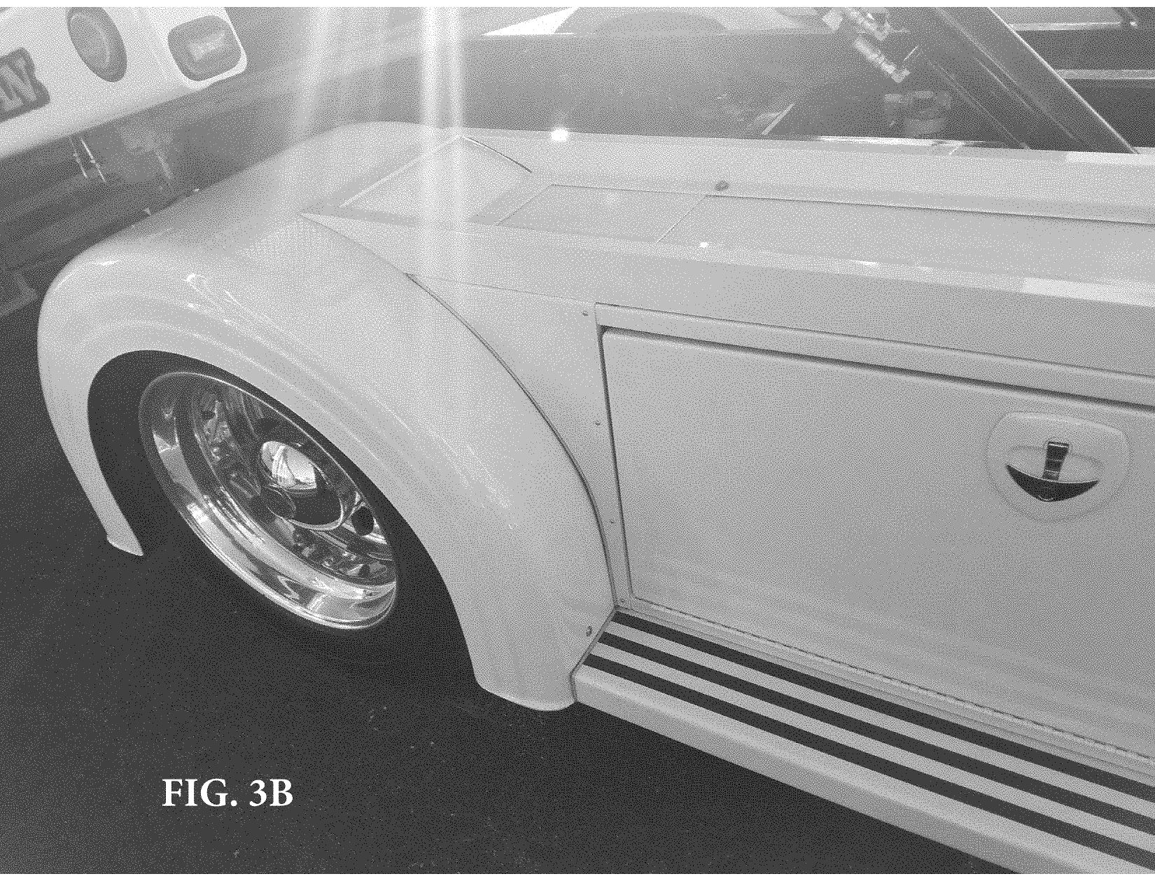

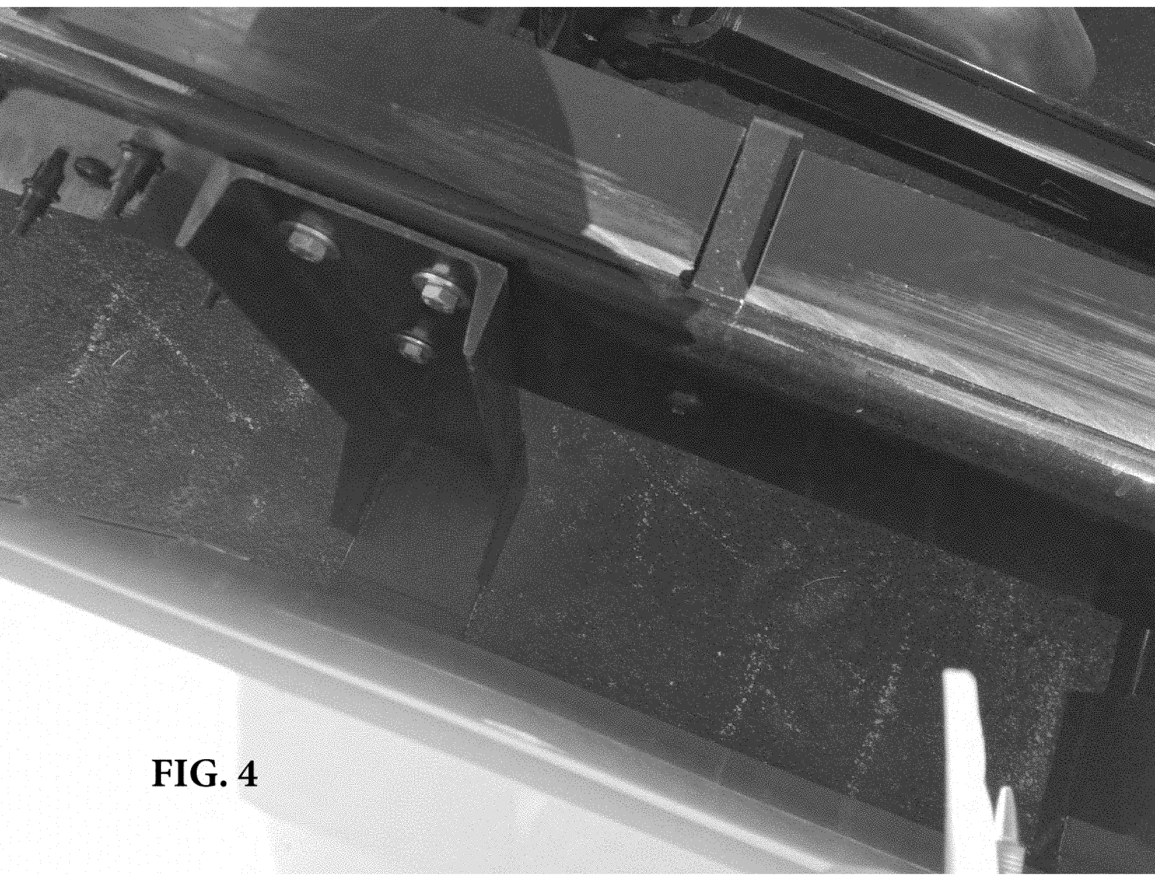

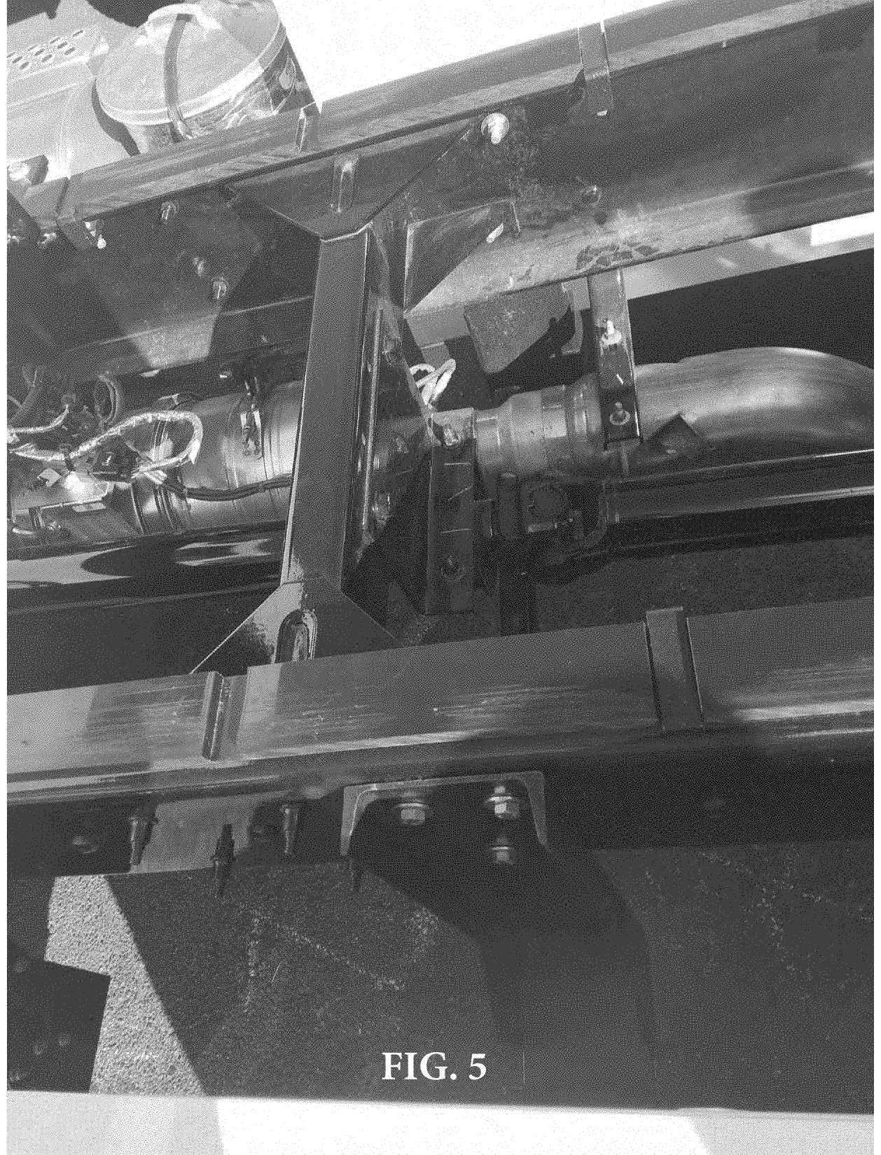

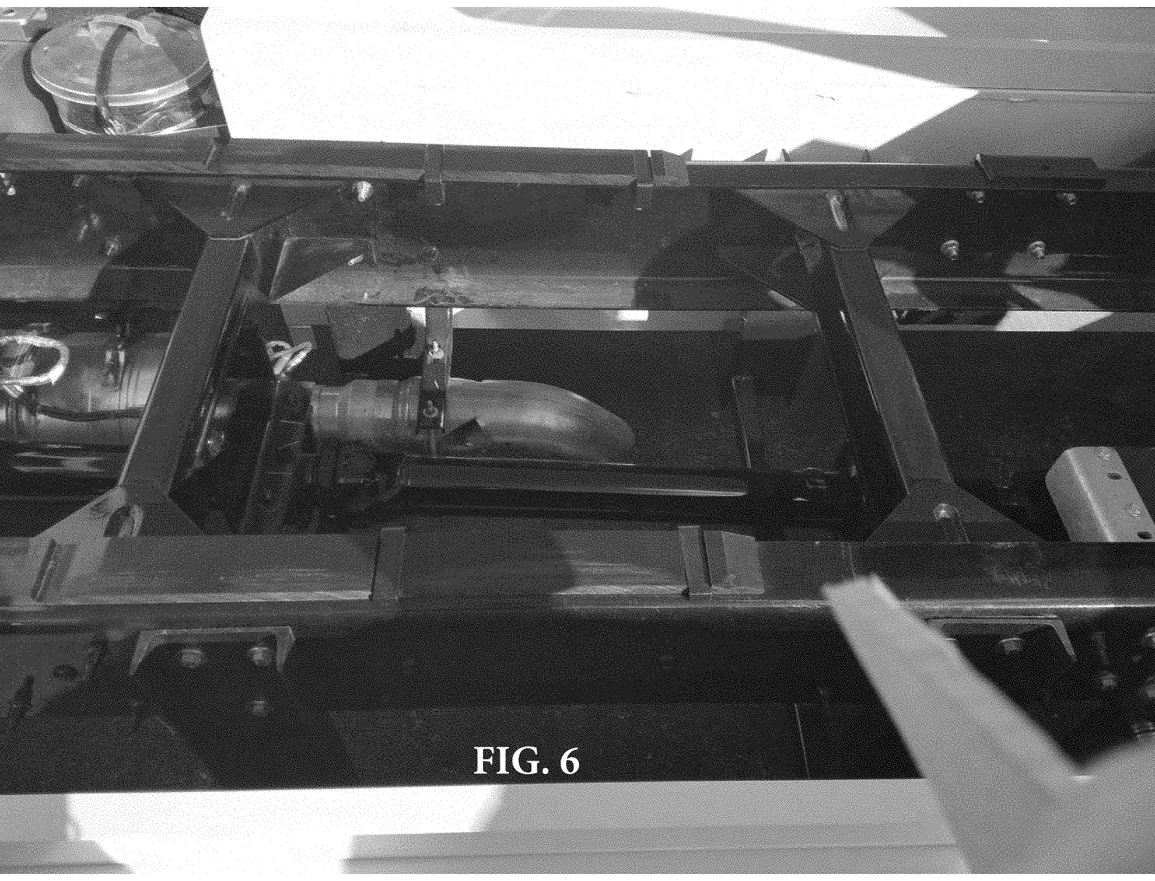

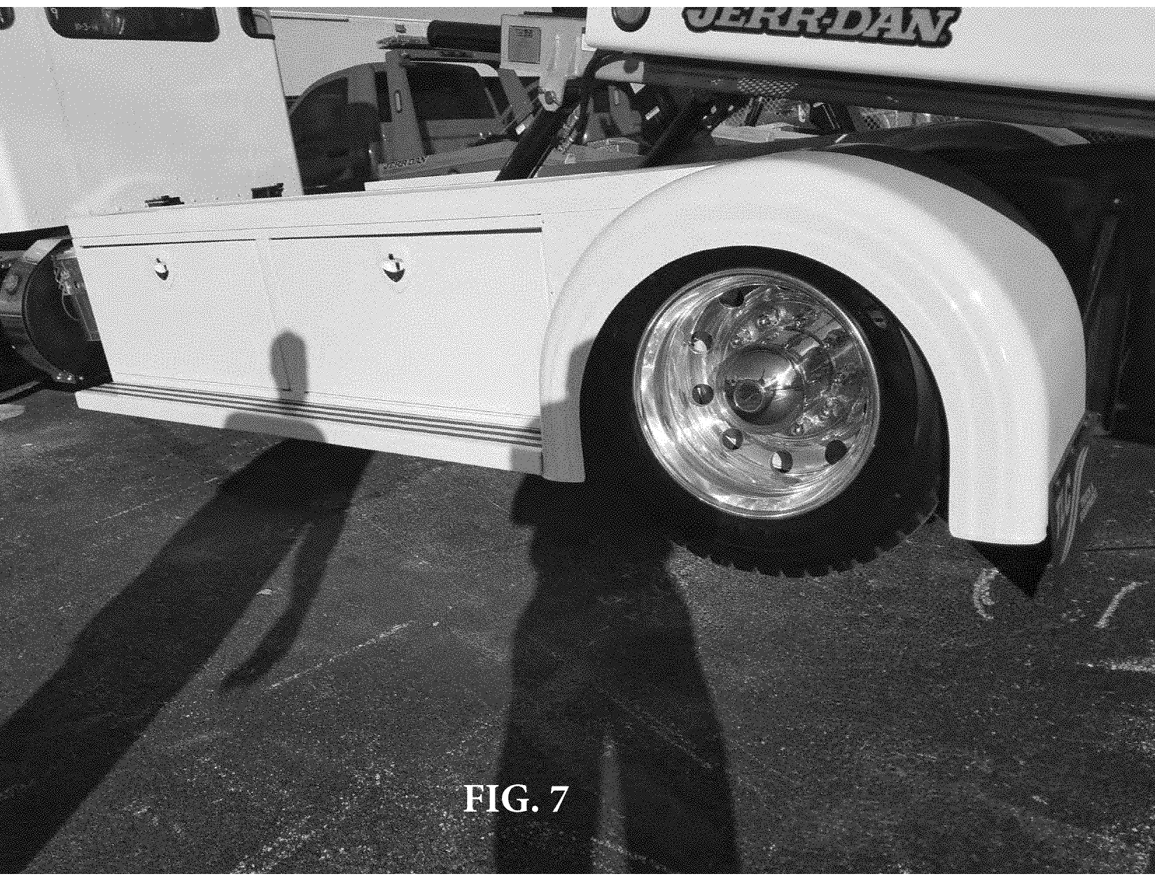

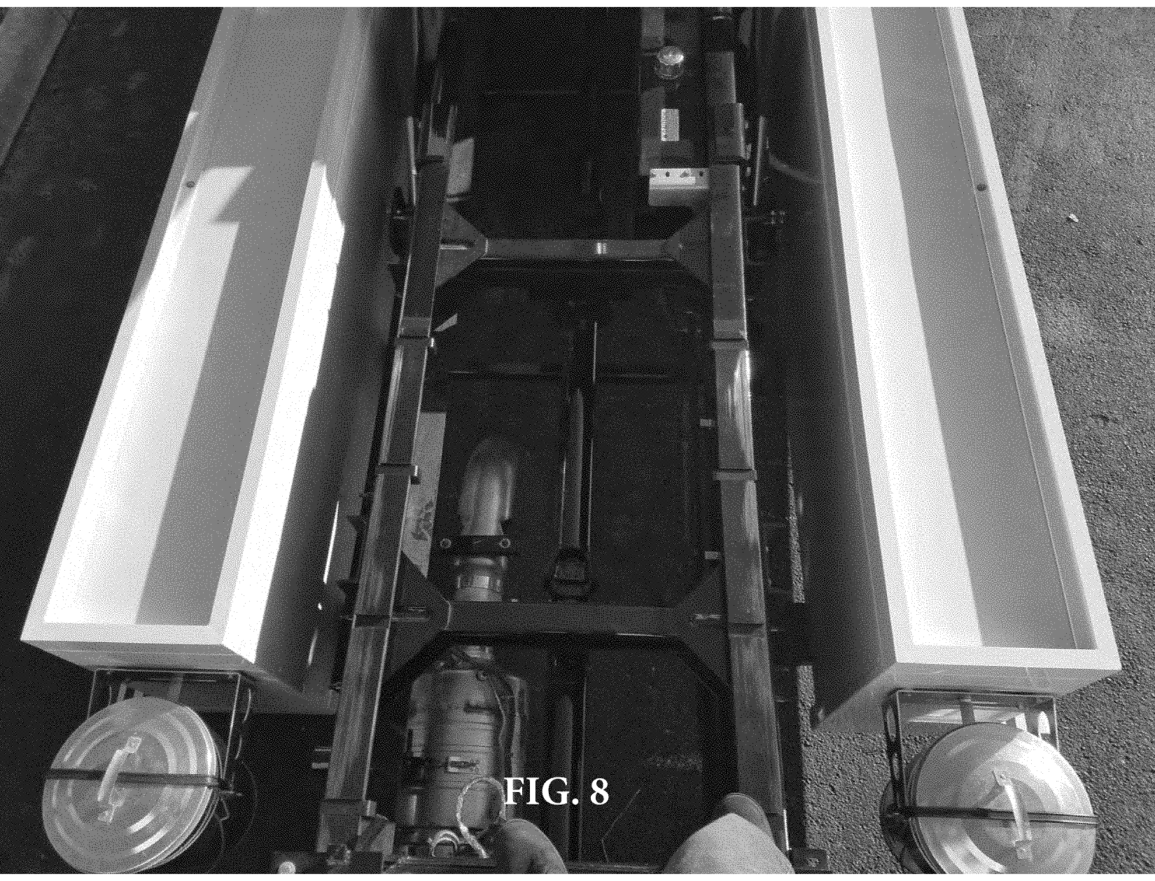

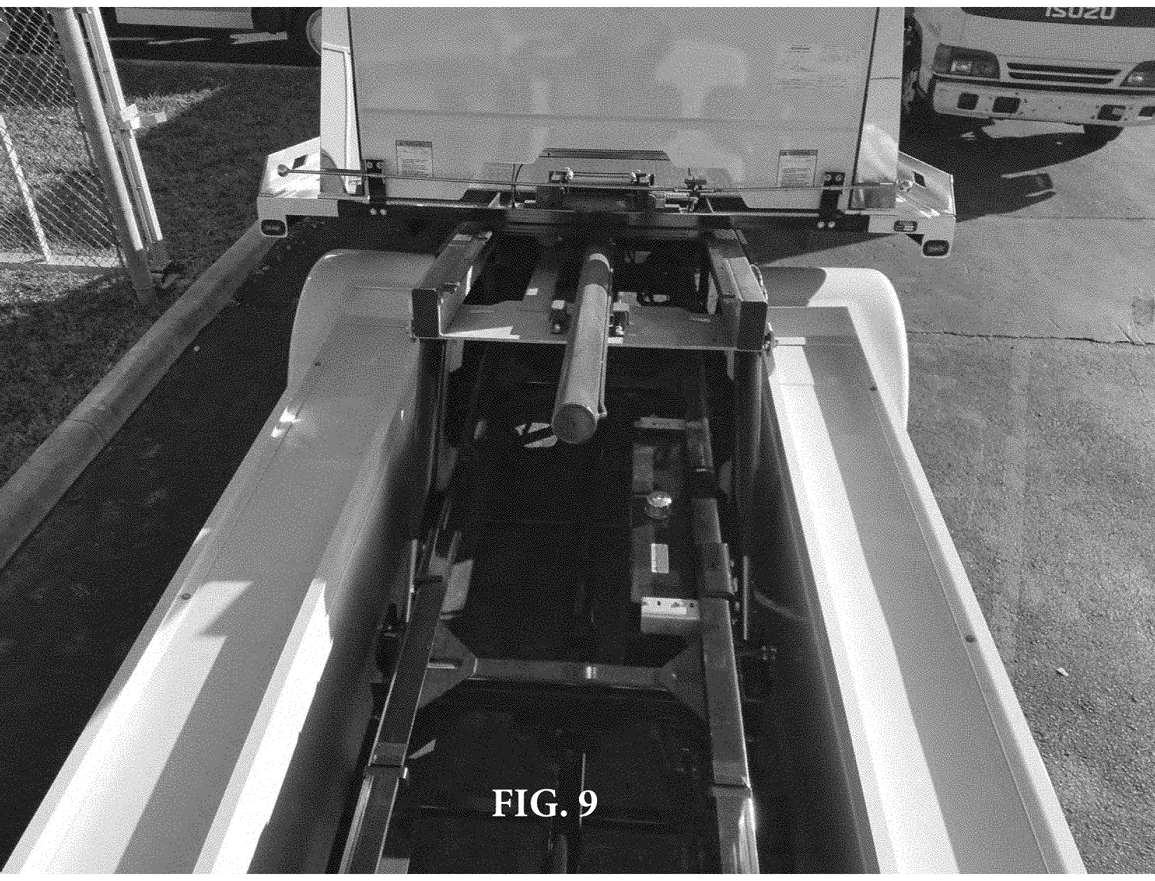

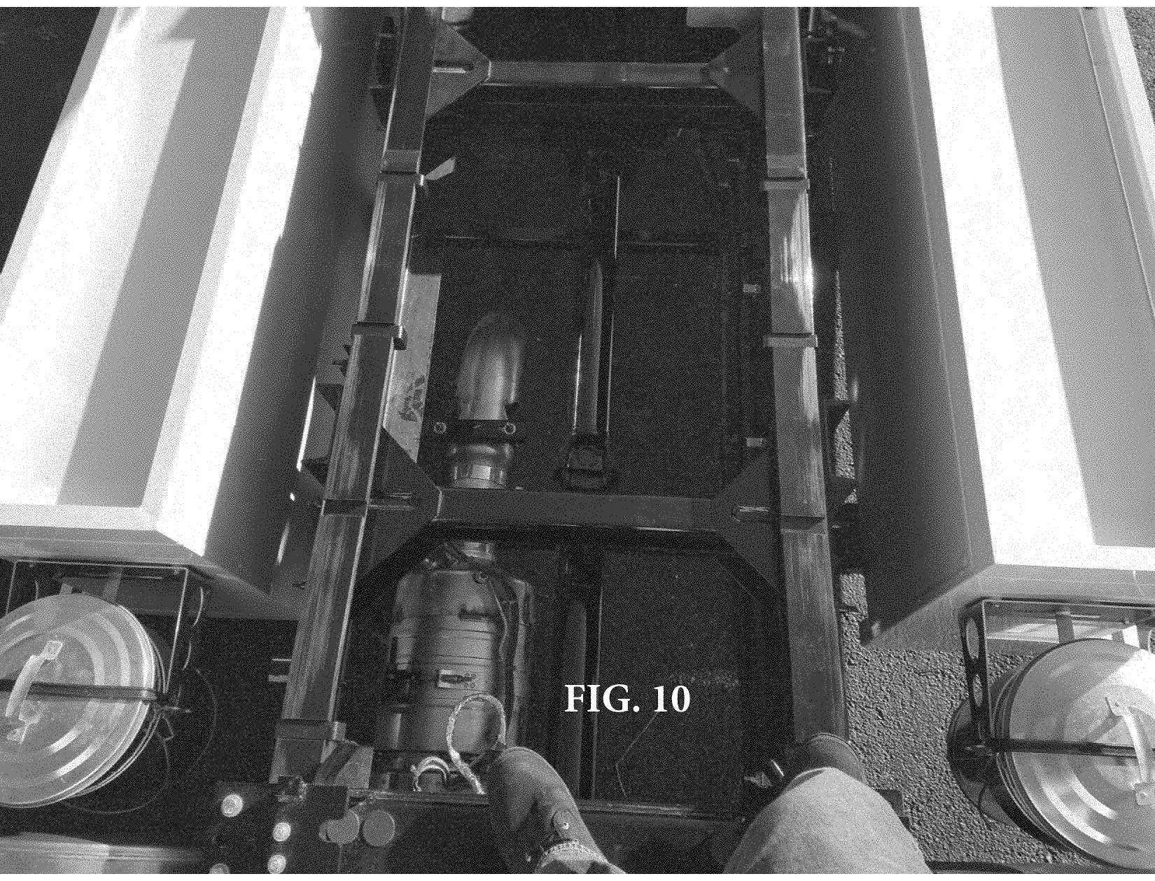

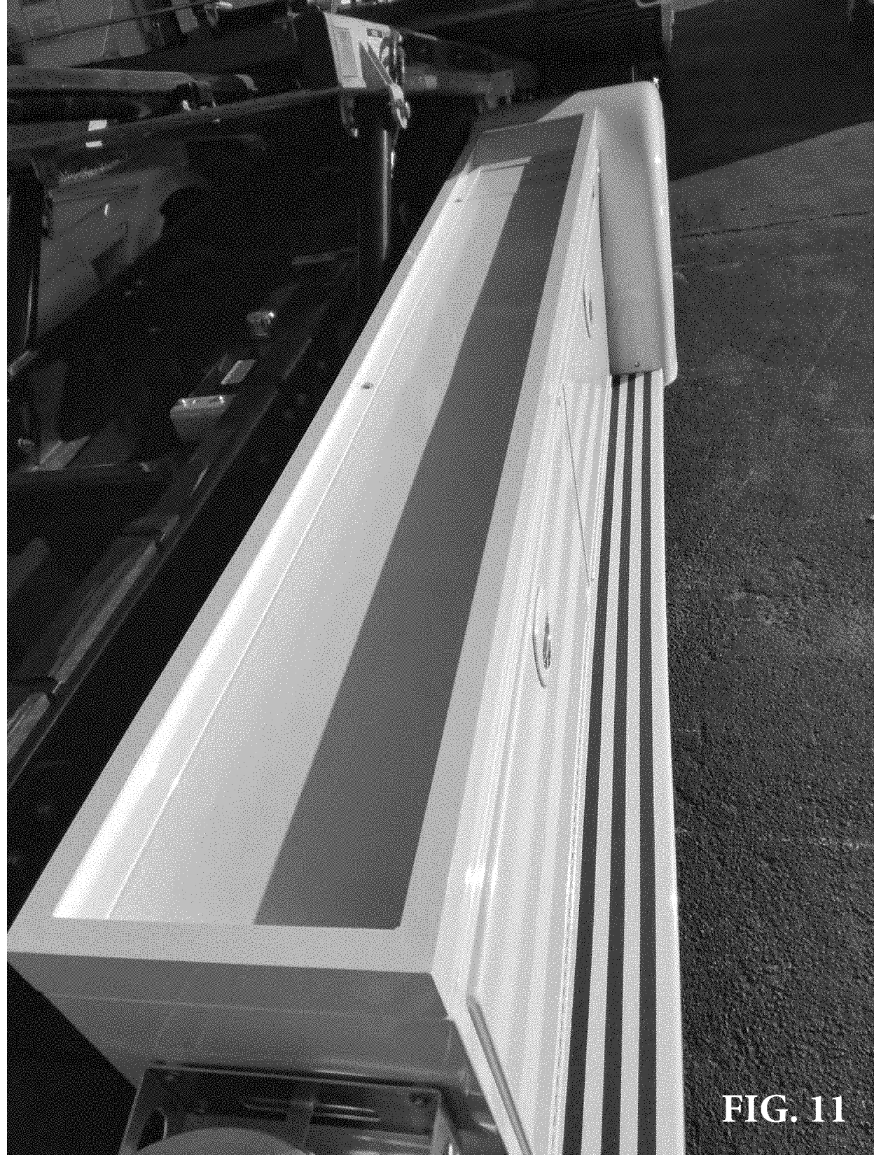

In an exemplary embodiment, a step can be placed onto the top surfaces of the support elements in floating configuration. The step is centered on the sub-frame and then bolted onto the sub-frame. A tool box is bolted onto the step and through the sub-frame so that bolts extend through both the step and the sub-frame. Optionally, a fender is bolted onto a rearward end of the step, as shown in FIG. 2.

The sub-frame, step, bolts, and brackets of the truck sub-frame and step assembly are made from metal, e.g., steel. The tool box and fender can be made from metal, plastic, fiberglass, or any other suitable materials.

The truck sub-frame and step assembly can be made in a left configuration for installation on left side of the truck and a right configuration for installation on the right side of the truck.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A sub-frame and step assembly comprising:
a sub-frame installed on a chassis of a truck; and
a step assembly connected to the sub-frame at a height that allows access by a user standing thereon to a bed of the truck.

2. The sub-frame and step assembly of claim 1, further comprising a tool box installed on the sub-frame.

3. A truck comprising:
a sub-frame installed on a chassis of the truck; and
a step assembly connected to the sub-frame.
